(19) United States
(12) Patent Application Publication
(10) Pub. No.: US 2024/0404746 A1
(43) Pub. Date: Dec. 5, 2024

(54) COIL COMPONENT

(71) Applicant: SAMSUNG ELECTRO-MECHANICS CO., LTD., Suwon-si (KR)

(72) Inventors: Dong Jin Lee, Suwon-si (KR); Dong Hwan Lee, Suwon-si (KR); Byeong Cheol Moon, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/444,559

(22) Filed: Feb. 16, 2024

(30) Foreign Application Priority Data
May 30, 2023 (KR) 10-2023-0069034

(51) Int. Cl. H01F 27/29; H01F 27/30

(52) U.S. Cl. CPC H01F 27/292; H01F 27/306

(57) ABSTRACT

According to an aspect of the present disclosure, a coil component includes a body including a first surface and a second surface opposing each other in a first direction, and a slit disposed in the first surface; a coil disposed in the body and including a coil portion having at least one turn, a lead-out portion extending from an outermost turn of the coil portion, and a protrusion extending to the slit; and an external electrode disposed on the slit to be in contact with the protrusion.

### CROSS-REFERENCE TO RELATED APPLICATION(S)

This application claims benefit of priority to Korean Patent Application No. 10-2023-0069034 filed on May 30, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, may be a representative passive electronic component used in an electronic device together with a resistor and a capacitor.

As an electronic device has been designed to have high-performance and a reduced size, the number of electronic components used in an electronic device has increased and a size thereof has been reduced.

Meanwhile, in the case of a low-profile coil component, as a magnetic material area covering upper and lower portions of a coil may decrease, inductance properties may degrade. To address this issue, there has been demand for a structure in which external electrodes are disposed within a thickness of the entire coil component.

### SUMMARY

An aspect of the present disclosure is to, by disposing an external electrode to be embedded in one surface of a body, reduce a thickness of an entire coil component.

An aspect of the present disclosure is to, by further disposing a protrusion on a lead-out portion of a coil such that reliability of connection between the coil and an external electrode may be maintained even when a slit depth is configured to be shallow, assure a maximum effective volume as compared to a coil component having the same thickness.

According to an aspect of the present disclosure, a coil component includes a body including a first surface and a second surface opposing each other in a first direction, and a slit disposed in the first surface; a coil disposed in the body and including a coil portion having at least one turn, a lead-out portion extending from an outermost turn of the coil portion, and a protrusion extending to the slit; and an external electrode disposed on the slit to be in contact with the protrusion.

According to another aspect of the present disclosure, a coil component includes a body including a slit disposed in one surface of the body; a first coil and a second coil disposed in the body, including a protrusion extending to the slit, having a turn in the same direction, and spaced apart from each other; and an external electrode disposed on the slit to be in contact with the protrusion. An innermost turn of the first coil forms a turn around a first core, and an innermost turn of the second coil forms a turn around a second core.

### BRIEF DESCRIPTION OF DRAWINGS

The above and other aspects, features, and advantages of the present disclosure will be more clearly understood from the following detailed description, taken in conjunction with the accompanying lead-outs, in which:

FIG. 1 is a perspective diagram illustrating a coil component according to a first embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is a plan diagram of FIG. 1;

FIG. 5 is a perspective diagram illustrating a coil component according to a second embodiment of the present disclosure;

FIG. 6 is a plan diagram of FIG. 5;

FIG. 7 is a perspective diagram illustrating a coil component according to a third embodiment of the present disclosure;

FIG. 8 is a plan diagram of FIG. 7;

FIG. 9 is a perspective diagram illustrating a coil component according to a fourth embodiment of the present disclosure;

FIG. 10 is a plan diagram of FIG. 9;

FIGS. 11 and 12 are diagrams illustrating a method of manufacturing a coil component according to a first embodiment of the present disclosure; and

FIG. 13 is a diagram illustrating a state in which a dry film is disposed to form a protrusion in a coil bar unit.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. An expression used in the singular encompasses the expression of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the expression that an element is disposed “On” may indicate that the element may be disposed above or below a target portion, and does not necessarily indicate the element is disposed above the target portion in the direction of gravity.

It will be understood that when an element (for example, a first element) is “(operatively or communicatively) coupled with/to” or “connected with” another element (for example, a second element), the element may be directly coupled with/to another element, and there may be an intervening element (for example, a third element) between the element and another element. To the contrary, it will be understood that when an element (for example, a first element) is “directly coupled with/to” or “directly connected to” another element (for example, a second element), there is no intervening element (for example, a third element) between the element and another element.

For example, structures, shapes, and sizes described as examples in embodiments in the present disclosure may be implemented in another exemplary embodiment without departing from the spirit and scope of the present disclosure.

In the drawings, the T direction may be defined as a first direction or a thickness direction, the L direction may be defined as a second direction or a length direction, and the W direction may be defined as a third direction or a width direction.

In the drawings, same elements will be indicated by same reference numerals. Also, redundant descriptions and detailed descriptions of known functions and elements that may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

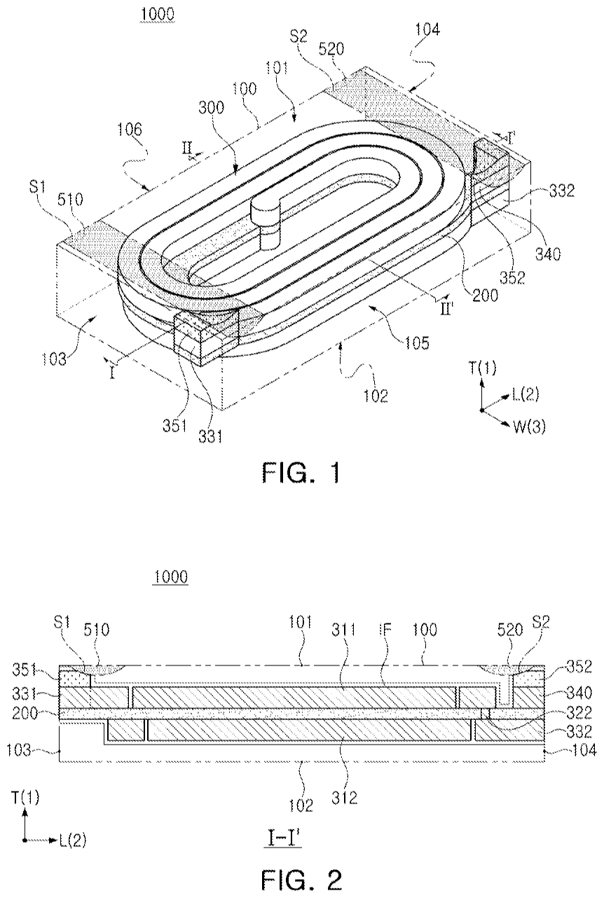

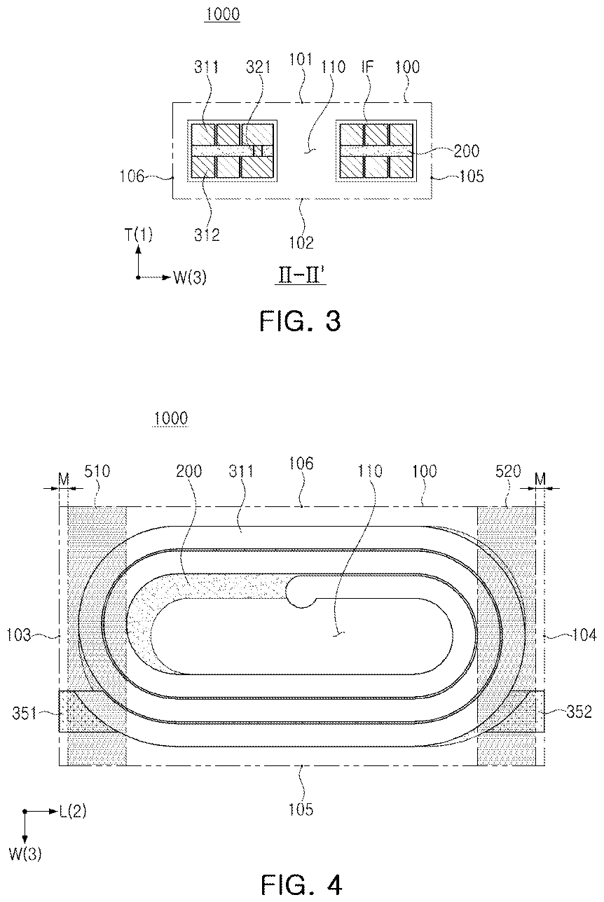

FIG. 1 is a perspective diagram illustrating a coil component according to a first embodiment. FIG. 2 is a cross-sectional diagram taken along line I-I′ in FIG. 1. FIG. 3 is a cross-sectional diagram taken along line II-II′ in FIG. 1. FIG. 4 is a plan diagram of FIG. 1.

Referring to FIGS. 1 to 4, the coil component 1000 according to the first embodiment may include a body 100, a coil 300, and external electrodes 510 and 520, and may further include a support member 200 supporting the coil 300.

In the coil component 1000 according to the embodiment, slits S1 and S2 may be formed on the first surface 101 of the body 100, and the external electrodes 510 and 520 may be disposed on the slits S1 and S2, such that an electrode structure may be implemented.

Also, the external electrodes 510 and 520 may not protrude beyond the first surface 101 of the body 100 and may be disposed to be embedded in the body 100, which may be advantageous for implementing low-profile of the coil component 1000.

As depths of the slits S1 and S2 decrease, a magnetic volume in the body 100 may be assured, and accordingly, as the coil 300 includes protrusions 351 and 352 disposed on both ends, even when the depths of the slits S1 and S2 are shallow, reliability of connection between the coil 300 and the external electrodes 510 and 520 may be assured.

Hereinafter, the main components included in the coil component 1000 according to the embodiment will be described in greater detail.

The body 100 may form an exterior of the coil component 1000 in the example embodiment, and the coil 300 and the support member 200 may be disposed therein.

The body 100 may have a hexahedral shape.

The body 100 may include a first surface 101 and a second surface 102 opposing each other in the thickness direction (T, the first direction), a third surface 103 and a fourth surface 104 opposing each other in the length direction (L, the second direction), and a fifth surface 105 and a sixth surface 106 opposing each other in the width direction (W, the third direction). Each of the first to fourth surfaces 101, 102, 103 and 104 of the body 100 may be a wall surface of the body 100 connecting the first surface 101 and the second surface 102 of the body 100.

The body 100 may be formed such that the coil component may have a length of 2.5 mm in the L direction, a width of 2.0 mm and a thickness of 0.8 mm, may have a length of 2.0 mm, a width of 1.2 mm and a thickness of 1.0 mm, may have a length of 2.0 mm, a width of 1.2 mm and a thickness of 0.6 mm, may a length of 1.6 mm, a width of 0.8 mm and a thickness of 0.6 mm, may have a length of 1.6 mm, a width of 0.8 mm and a thickness of 0.4 mm, may have a length of 1.4 mm, a width of 1.2 mm and a thickness of 0.65 mm, may have a length of 1.0 mm, a width of 0.7 mm and a thickness of 0.65 mm, may have a length of 0.8 mm, a width of 0.4 mm and a thickness of 0.65 mm, or may have a length of 0.8 mm, a width of 0.4 mm and a thickness of 0. 5 mm, but an embodiment thereof is not limited thereto. Since the above-described numerical value examples for the length, width, and thickness of the coil component 1000 may not reflect process errors, and a numerical value in a range recognized as a process error may correspond to the above-described numerical value examples.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the thickness of the coil component 1000 may refer to a minimum value among the dimensions of the plurality of line segments described above. Alternatively, the thickness of the coil component 1000 may refer to an arithmetic mean value of at least three or more of the dimensions of the plurality of line segments described above. Here, the plurality of line segments parallel to the thickness direction T may be spaced apart from each other by an equal distance in the length direction L, but an example embodiment thereof is not limited thereto.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments described above. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments described above. Alternatively, the width of the coil component 1000 may refer to an arithmetic mean value of at least three or more of the dimensions of the plurality of line segments described above. Here, the plurality of line segments parallel to the width direction W may be spaced apart from each other by an equal distance in the length direction L, but an example embodiment thereof is not limited thereto.

Alternatively, each of the length, a width and thickness of the coil component 1000 may be measured by a micrometer measurement method. The micrometer measurement method may be of determining a zero point with a gage repeatability and reproducibility (R&R) micrometer, inserting the coil component 1000 in the example embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include a magnetic material and resin. Specifically, the body 100 may be formed by laminating one or more magnetic composite sheets in which a magnetic material is dispersed in an insulating resin. The body 100 may have a structure other than a structure in which a magnetic material is dispersed in resin. For example, the body 100 may be formed of a magnetic material such as ferrite.

The magnetic material may be ferrite or a magnetic metal powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

The magnetic metal powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The magnetic metal powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

The resin may include epoxy, polyimide, a liquid crystal polymer, or the like, alone or in combination but an example embodiment thereof is not limited thereto.

The body 100 may include a first core 110 penetrating through the support member 200 and the coil 300. The first core 110 may be formed by filling the through hole in the support member 200 and the coil 300 with a magnetic composite sheet, but an embodiment thereof is not limited thereto.

Referring to FIGS. 1 and 2, the slits S1 and S2 may be formed on the first surface 101 of the body 100.

Specifically, the first slit S1 and the second slit S2 spaced apart from each other in the second direction L may be formed on the first surface 101 of the body 100, and the first slit S1 and the second slit S2 may extend to the fifth surface 105 and the sixth surface 106, respectively, in a shape parallel to the third direction W. However, an example embodiment thereof is not limited thereto, and, as an example, at least one of the first slit S1 and the second slit S2 may not extend to the fifth surface 105 and the sixth surface 106 and may be configured to be smaller than the width of the body 100 in the third direction W.

Referring to FIG. 4, the slits S1 and S2 may be spaced apart from the third surface 103 and the fourth surface 104 of the body 100.

Specifically, the first slit S1 may be formed to have a constant distance, that is, a margin M, from the third surface 103 of the body 100, and the second slit S2 may be formed to have a constant margin M from the fourth surface 103 of the body 100.

Through this structure, plating bleeding may be alleviated when the external electrodes 510 and 520 are disposed on the slits S1 and S2, and a dicing margin may be assured in a dicing process.

Referring to FIGS. 1 and 2, inner surfaces of the slits S1 and S2 may include curved surfaces. In the coil component 1000 according to the embodiment, the inner surfaces of slits S1 and S2 may have a U-shape and may be inwardly curved, but an example embodiment thereof is not limited thereto, and the inner surfaces may have various shapes such as a V-shape, stepped shape, recessed shape, an even shape, or the like, if desired. The shapes of slits S1 and S2 may have a shape corresponding to the shape of a dicing blade used during a pre-dicing process.

The slits S1 and S2 may be formed by performing pre-dicing in parallel with the third direction W on the first surface 101 of a coil bar in a coil bar unit, which is in a state before each coil component is individualized. A depth of the pre-dicing may be adjusted such that protrusions 351 and 352 may be exposed to the slits S1 and S2.

In other words, the depths of the slits S1 and S2 may be formed such that the external electrodes 510 and 520 disposed on the slits S1 and S2 and the protrusions 351 and 352 may be in contact with each other and reliability of electrical connection may be assured. For example, the depth may be formed at 40 μm, but an example embodiment thereof is not limited thereto.

The support member 200 may be disposed in the body 100 and may have one surface and the other surface opposing each other. With respect to the direction in FIG. 1, one surface of the support member 200 may correspond to an upper surface, and the other surface of the support member 200 may correspond to a lower surface.

The support member 200 may be a component supporting the coil 300.

Referring to FIGS. 2 and 3, the support member 200 may support a first coil portion 311, a first lead-out portion 331, a sub-lead-out portion 340, and the protrusions 351 and 352 disposed on one surface, and a second coil portion 312 and a second lead-out portion 332 disposed on the other surface.

The support member 200 of the coil component 1000 according to the embodiment may be disposed to be exposed to the third surface 103 and the fourth surface 104 of the body 100.

Meanwhile, the support member 200 may not be provided in an embodiment, such as when the coil 300 is configured as a wound coil or has a coreless structure.

The support member 200 may be formed of thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the substrate 200 may be formed of an insulating material such as prepreg, Ajinomoto build-up film (ABF), FR-4, bismaleimide triazine (BT) film, and photo imaginable dielectric (PID) film, but an example embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the support member 200 is formed of an insulating material including a reinforcing material, the support member 200 may provide improved rigidity. When the support member 200 is formed of an insulating material not including glass fibers, it may be advantageous to reduce a thickness of a component by reducing the overall thickness of the support member 200 and the coil 300 (indicating a sum of dimensions of the coil 300 and the support member 200 in the first direction T in FIG. 1). When the support member 200 is formed of an insulating material including a photosensitive insulating resin, the number of processes for forming the coil 300 may be reduced, which may be advantageous in reducing production costs, and the first via 321 and the second via 322 may be formed finely. The thickness of the support member 200 may be, for example, 10 μm or more and 50 μm or less, but an embodiment thereof is not limited thereto.

The coil 300 may be embedded in the body 100, and may exhibit properties of the coil component 1000. For example, when the coil component 1000 in the example embodiment is used as a power inductor, the coil 300 may maintain an output voltage by storing an electric field as a magnetic field, thereby stabilizing power of the electronic device.

The coil 300 may include a first coil portion 311, a second coil portion 312, a first lead-out portion 331, a second lead-out portion 332, a sub-lead-out portion 340, a first protrusion 351, and a second protrusion 352, and may further include a first via 321 connecting the first coil portion 311 to the second coil portion 312, and a second via 322 connecting the second lead-out portion 332 to the sub-lead-out portion 340.

Referring to FIG. 2, the first coil portion 311, the first lead-out portion 331, and the sub-lead-out portion 340 may be disposed on one surface (an upper surface) of the support member 200 opposing the first surface 101 of the body 100, and the second coil portion 312 and the second lead-out portion 332 may be disposed on the other surface (a lower surface) of the support member 200 opposing the second surface 102 of the body 100.

Also, the first protrusion 351 may be disposed on the first lead-out portion 331, and the second protrusion 352 may be disposed on the sub-lead-out portion 340.

Referring to FIGS. 1 to 4, the first coil portion 311 may be disposed on one surface of the support member 200 and may form at least one turn centered on the first core 110, and an outermost turn may extend and may be in contact with and connected to the first lead-out portion 331. The first coil portion 311 may have a planar helical shape, but an example embodiment thereof is not limited thereto, and the first coil portion 311 may also have an angled shape.

Similarly, the second coil portion 312 may be disposed on the other surface of the support member 200 and may form at least one turn centered on the first core 110, and an outermost turn may extend and may be in contact with the second lead-out portion 332. The second coil portion 312 may have a planar helical shape, but an example embodiment thereof is not limited thereto, and the second coil portion 312 may also have an angled shape.

Referring to FIG. 3, the first via 321 may be a component connecting the first coil portion 311 to the second coil portion 312 disposed on both surfaces of the support member 200. Specifically, the first via 321 may penetrate through the support member 200 and may connect ends of the innermost turns of the first coil portion 311 and the second coil portion 312 to each other.

The first lead-out portion 331 may be disposed on one surface of the support member 200 and may be disposed to extend from the outermost turn of the first coil portion 311 to the third surface 103 of the body 100. The first lead-out portion 331 exposed to the third surface 103 of the body 100 may be covered by an external insulating layer.

The second lead-out portion 332 may be disposed on the other surface of the support member 200 and may be disposed to extend from the outermost turn of the second coil portion 312 to the fourth surface 104 of the body 100. The second lead-out portion 332 exposed to the fourth surface 104 of the body 100 may be covered by an external insulating layer.

Referring to FIGS. 1 and 2, the sub-lead-out portion 340 may be spaced apart from the first coil portion 311 on one surface of the support member 200. The sub-lead-out portion 340 may be a component functioning the same as extending the second lead-out portion 332 on the other surface of the support member 200 to one surface of the support member 200 to implement a lower electrode structure.

Meanwhile, in the embodiment, the sub-lead-out portion 340 may have an asymmetric structure in which the sub-lead-out portion 340 is disposed only on the fourth surface 104 side of the body 100 on one surface of the support member 200, but an example embodiment thereof is not limited thereto, and the sub-lead-out portion 340 may be further disposed on the third surface 103 of the body 100 on the other surface of support member 200 and may further include another sub-lead-out portion extending to the third surface 103 of the body 100.

However, in an asymmetric structure in which the sub-lead-out portion 340 is formed only on one side of the body 100 as in the embodiment, as compared to a symmetric structure further including an additional sub-lead-out portion, a space filled with a magnetic material may be further assured in the body 100, an effective volume may increase, which may be advantageous in terms of inductance properties.

Referring to FIG. 2, the second via 322 may be a component connecting the second lead-out portion 332 to the sub-lead-out portion 340 disposed on both surfaces of the support member 200. Specifically, the second via 322 may connect the second lead-out portion 332 to the sub-lead-out portion 340 by penetrating through the support member 200.

Referring to FIGS. 1, 2 and 4, the first protrusion 351 may be disposed on the first lead-out portion 331, and the second protrusion 352 may be disposed on the sub-lead-out portion 340.

The first protrusion 351 and the second protrusion 352 may be components for electrical connection between the coil 300 and the external electrodes 510 and 520.

In the embodiment, the protrusions 351 and 352 may be components formed through additional plating after the coil portions 311 and 312, the lead-out portions 331 and 332, and the sub-lead-out portion 340 are disposed.

Also, during the pre-dicing process for forming the slits S1 and S2 on the first surface 101 of body 100, a portion of the protrusions 351 and 352 may also be removed, such that at least a portion of the protrusions 351 and 352 may be coplanar with the slits S1 and S2.

As described above, the exposed region of the protrusions 351 and 352, which is coplanar with the inner surfaces of slits S1 and S2, may be in direct contact with the external electrodes 510 and 520 disposed on the slits S1 and S2.

Before the external electrodes 510 and 520 are disposed, the protrusions 351 and 352 may be components of which at least a portion may be exposed externally through the slits S1 and S2.

Specifically, the first protrusion 351 may be exposed by extending from the first lead-out portion 331 to the first slit S1, and the second protrusion 352 may be exposed by extending from the sub-lead-out portion 340 to the second slit S2.

Referring to FIGS. 1 and 2, a boundary surface may be formed between the first protrusion 351 and the first lead-out portion 331. Similarly, a boundary surface may be formed between the second protrusion 352 and the sub-lead-out portion 340.

The above feature may be observed on a cross-section of coil component 1000 when the protrusions 351 and 352 are formed through additional plating.

Since the protrusions 351 and 352 are disposed in the body 100, in the coil component 1000 according to the embodiment, the external electrodes 510 and 520 may be disposed directly on an outer surface of body 100, for example, the third surface 103 and the fourth surface 104, as compared to the structure extending to the first surface 101, a thickness of the body 100 may be increased as compared to the coil component having the same thickness, such that a proportion of a magnetic material in the coil component 1000 may increase, and inductance properties may be improved.

Through the connection between the components described above, a signal input to the first external electrode 510 may be output to the second external electrode 520 by passing through the first protrusion 351, the first lead-out portion 331, the first coil portion 311, the first via 321, the second coil portion 312, the second lead-out portion 332, the second via 322, the sub-lead-out portion 340, and the second protrusion 352. Through this structure, each component of the coil 300 may function as a single coil connected between the first external electrode 510 and the second external electrode 520.

At least one of the coil portions 311 and 312, vias 321 and 322, the lead-out portions 331 and 332, and the sub-lead-out portions 340 may include one or more conductive layers. For example, when the first coil portion 311, the first via 321, the first lead-out portion 331, and the sub-lead-out portion 340 are formed on one surface of the support member 200 by plating, each of the first coil portion 311, the first via 321, the first lead-out portion 331, and the sub-lead-out portion 340 may include a first conductive layer formed by electroless plating, and a second conductive layer disposed on the first conductive layer.

The first conductive layer may be a seed layer for forming a second conductive layer on the support member 200 by plating, and the second conductive layer may be an electroplating layer. Here, the electroplating layer may have a single-layer structure or a multilayer structure. The electroplating layer having a multilayer structure may be formed as a conformal film structure in which one electroplating layer is covered by another electroplating layer, and one electroplating layer may be laminated on one surface of another electroplating layer. The seed layer of the first coil portion 311 and the seed layer of the first lead-out portion 331 may be formed integrally and a boundary may not be formed therebetween, but an embodiment thereof is not limited thereto. Also, the electroplating layer of the first coil portion 311 and the electroplating layer of the first lead-out portion 331 may be integrally formed such that no boundary may be formed therebetween, but an embodiment thereof is not limited thereto.

The protrusions 351 and 352 may be formed by additional plating through a masking process using a dry film after the coil portions 311 and 312, the vias 321 and 322, the lead-out portions 331 and 332, and the sub-lead-out portions 340 are formed, but an example embodiment thereof is not limited thereto.

Each of the coil portions 311 and 312, the vias 321 and 322, the lead-out portions 331 and 332, the sub-lead-out portions 340, and the protrusions 351 and 352 may include a conductive material such as copper (Cu), aluminum (Al), silver (Ag), tin (Sn), gold (Au), nickel (Ni), lead (Pb), titanium (Ti), or alloys thereof.

Referring to FIGS. 2 and 3, the coil component 1000 according to the embodiment may further include an insulating film IF within the body 100.

The coil portions 311 and 312, the lead-out portions 331 and 332, the sub-lead-out portions 340, and the protrusions 351 and 352 may be insulated from the body 100.

The insulating film IF may include, for example, parylene, but an embodiment thereof is not limited thereto. The insulating film IF may be formed by a method such as vapor deposition, but an example embodiment thereof is not limited thereto, and may be formed by laminating an insulating film on both surfaces of the support member 200.

Meanwhile, the insulating film IF may have a structure including a portion of a plating resist used in forming the coil 300 by electroplating, but an embodiment thereof is not limited thereto.

Referring to FIGS. 1, 2, and 4, the first external electrode 510 and the second external electrode 520 may be spaced apart from each other on the first surface 101 of the body 100, and the first external electrode 510 may extend to the first slit S1 and may be connected to the first protrusion 351, and the second external electrode 520 may extend to the second slit S2 and may be in contact with the second protrusion 352.

Since the external electrodes 510 and 520 of the coil component 1000 according to the embodiment are disposed in the slit S1 and S2 regions, the external electrodes 510 and 520 may be embedded in the body 100 and may not protrude further than the first surface 101.

Accordingly, the component may not have a thickness extending externally of the body 100, which may be advantageous for implementing low-profile of the coil component 1000.

Also, since the external electrodes 510 and 520 of the coil component 1000 according to the embodiment are disposed in the slit S1 and S2 regions, the external electrodes 510 and 520 may be spaced apart from the third surface 103 and the fourth surface 104 of the body 100 similarly to the slits S1 and S2.

Accordingly, a risk of defects such as plating bleeding may be reduced when the external electrodes 510 and 520 are formed.

The external electrodes 510 and 520 may be disposed to fill the entire slit S1 and S2 regions, or may also be formed in the form of a conformal film on the inner surfaces of the slit S1 and S2, and in this case, the external electrodes 510 and 520 may be formed through a thin film process such as a sputtering process or a plating process.

The external electrode 510 and 520 may be formed of a conductive material such as copper (Cu), aluminum (Al), silver (Ag), tin (Sn), gold (Au), platinum (Pt), palladium (Pd), nickel (Ni), lead (Pb), chromium (Cr), titanium (Ti), or alloys thereof, but an example embodiment thereof is not limited thereto.

The external electrodes 510 and 520 may be formed in a multilayer structure. For example, the first layer on which the external electrodes 510 and 520 are connected to the coil 300 may be a conductive resin layer including conductive powder including at least one of copper (Cu) and silver (Ag) and insulating resin, or may be a copper (Cu) plating layer. Also, the second layer may have a double-layer structure including a nickel (Ni) plating layer and a tin (Sn) plating layer.

The first layer may be formed by electroplating, vapor deposition such as sputtering, or by applying and curing a conductive paste including conductive powder such as copper (Cu) and/or silver (Ag). The second layer may be formed by electroplating.

Although not illustrated, the coil component 1000 according to the embodiment may further include an external insulating layer covering the body 100 and exposing the external electrodes 510 and 520 on the first surface 101 of the body 100.

The external insulating layer may cover the second surface 102, the third surface 103, the fourth surface 104, the fifth surface 105 and the sixth surface 106 of the body 100, and may expose the external electrodes 510 and 520 on the first surface 101 of the body 100.

For example, the external insulating layer may be formed by applying and curing an insulating material including resin to the surface of the body 100. In this case, the external insulating layer may be formed of a thermoplastic resin such as polystyrene resin, vinyl acetate resin, polyester resin, polyethylene resin, polypropylene resin, polyamide resin, rubber resin, acrylic resin, and a thermosetting resin and a photosensitive insulating resin such as phenol resin, epoxy resin, urethane resin, melamine resin, and alkyd resin.

### Second and Third Embodiments

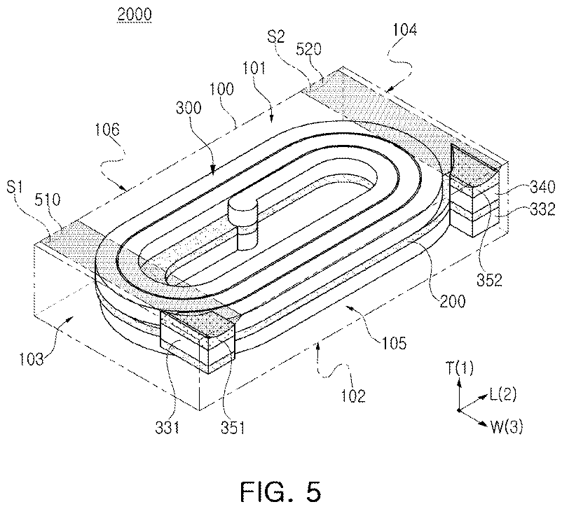

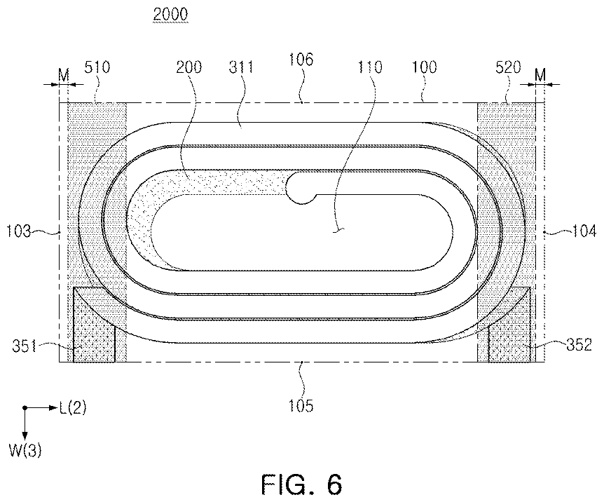

FIG. 5 is a perspective diagram illustrating a coil component according to a second embodiment. FIG. 6 is a plan diagram of FIG. 5.

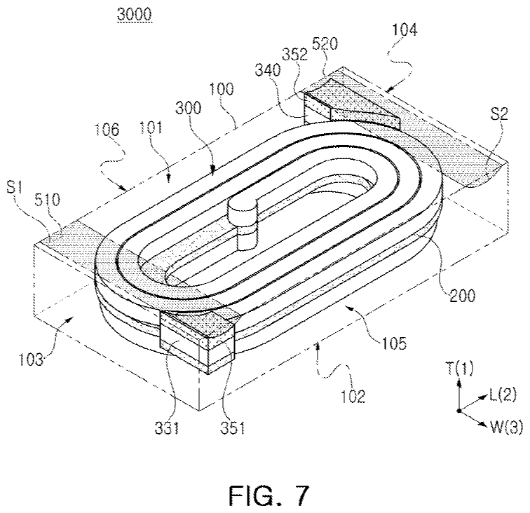

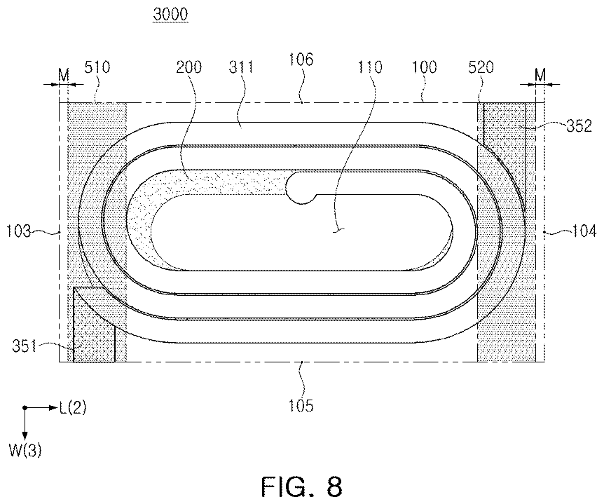

FIG. 7 is a perspective diagram illustrating a coil component according to a third embodiment. FIG. 8 is a plan diagram of FIG. 7.

When comparing the coil component 2000 according to the second embodiment and the coil component 3000 according to the third embodiment with the coil component 1000 according to the first embodiment, the extension directions of the lead-out portions 331 and 332 may be different, and accordingly, the extension directions of the sub-lead-out portion 340 and the protrusions 351 and 352 may also be different.

Accordingly, in describing the embodiments, only the arrangement of the lead-out portions 331 and 332, the sub-lead-out portions 340, and the protrusions 351 and 352, which are different from the first embodiment, will be described, and the description of the first embodiment may be applied to the other components in the embodiments.

Referring to FIGS. 5 and 6, the lead-out portions 331 and 322 of the coil component 2000 according to the second embodiment may extend to the fifth surface 105 of the body 100. That is, both ends of the coil portions 311 and 312 may extend in the third direction W and may be in contact with the fifth surface 105 of the body 100.

Also, the first protrusion 351 disposed on the first lead-out portion 331, the sub-lead-out portion 340 connected to the second lead-out portion 332, and the second protrusion 352 disposed on the sub-lead-out portion 340 may also disposed on the fifth surface 105 of the body 100.

In the coil component 2000 according to the second embodiment, the risk of short circuit with other adjacent components disposed in the second direction L may be reduced, and, if desired, the coil component 2000 may be used as a lower electrode structure having a vertical coil by extending the external electrodes 510 and 520 to the fifth surface 105 of body 100.

Referring to FIGS. 7 and 8, in the coil component 3000 according to the third embodiment, the first lead-out portion 331 may extend to the fifth surface 105 of the body 100, and the second lead-out portion 322 may extend to the sixth surface 106 of the body 100. That is, both ends of the coil portions 311 and 312 extend in opposite directions parallel to the third direction W and may be in contact with the fifth surface 105 and the sixth surface 106 of the body 100, respectively.

Also, the first protrusion 351 disposed on the first lead-out portion 331 may extend to the fifth surface 105 of the body 100, the sub-lead-out portion 340 connected to the second lead-out portion 332, and the second protrusion 352 disposed on the sub-lead-out portion 340 may extend to the sixth surface 106 of the body 100.

In the case of the coil component 3000 according to the third embodiment, the drawing directions of both ends of the coil 300 may be symmetrical to each other, such that structural stability may be increased and the coil component 3000 may have strong properties against warpage due to external forces.

The degree of design freedom in relation to the direction of the lead-out portions 311 and 312 may be high as in the above-described embodiments due to the connection to the external electrodes 510 and 520 by the protrusions 351 and 352, and more specifically, regardless of the direction in which the coil 300 is led out, the external electrodes 510 and 520 of the first surface 101 of the body 100 and the coil 300 may be connected to each other by the protrusion 351 and 352.

### Fourth Embodiment

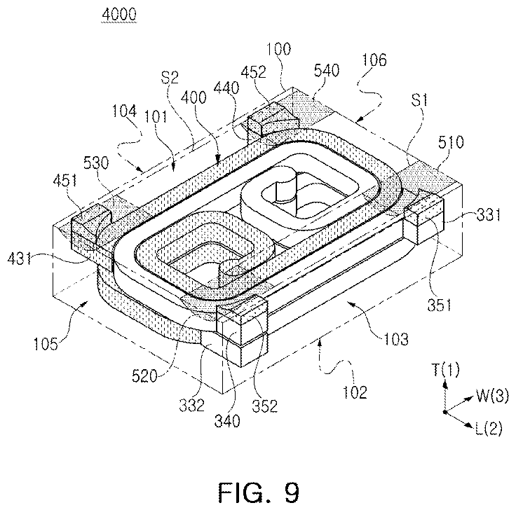

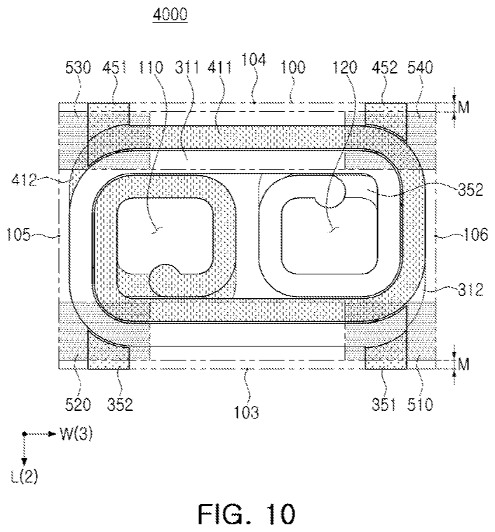

FIG. 9 is a perspective diagram illustrating a coil component according to a fourth embodiment. FIG. 10 is a plan diagram of FIG. 9.

When comparing the coil component 4000 according to the embodiment with the coil component 1000 according to the first embodiment, the coil component 4000 may include a first coil 300 and a second coil 400 corresponding to coupled inductors and magnetically coupled to each other.

Accordingly, in the embodiment, four lead-out portions 331 and 332, 431, and 432, two sub-lead-out portions 340 and 440, four protrusions 351 and 352, 451, and 452, and four external electrodes 510 and 520, 530, and 540 included in the coil 300 and 400 may be included.

Also, in the embodiment, the support member 200 may not be provided.

Accordingly, in describing the embodiment, only the support member and the coil 300 and 400 structures different from the first embodiment will be described, and the description of the first embodiment may be applied to the other components in the embodiments.

Referring to FIGS. 9 and 10, the coil component 4000 according to the embodiment may include a first coil 300 and a second coil 400 spaced apart from each other. The first coil 300 and the second coil 400 may be formed in two layers, and may have a coreless structure not including the support member 200 between the layers. In this case, the coils 300 and 400 may be supported by the insulating film IF and insulation from each other may be maintained, but an example embodiment thereof is not limited thereto.

When the support member 200 is not provided as in the embodiment, it may be advantageous to implement low-profile of the coil component 4000 as compared to the example in which the support member 200 is included, and when assuming the same thickness, a larger volume of magnetic material may be included, thereby improving inductance properties.

Referring to FIGS. 9 and 10, the body 100 may include a first core 110 and a second core 120, an innermost turn of the first coil 300 may form a turn centered on the first core 110, and an innermost turn of the second coil 400 may form a turn centered on the second core 120.

Also, an outermost turn of the first coil 300 may be disposed to surround the first core 110 and the second core 120, and an outermost turn of the second coil 400 may also be disposed to surround the first core 110 and the second core 120.

As described above a portion of turns of the coils 300 and 400 may be disposed independently on the core 110 and 120, respectively and the other portion may be disposed to share the two cores 110 and 120, such that magnetic coupling coefficient (k) design may be easily implemented.

Referring to FIGS. 9 and 10, two slits S1 and S2 may be formed in the body 100 parallel to the third direction W and spaced apart from each other, two for each slit, a total of four external electrodes 510 and 520, 530, and 540, may be disposed.

Specifically, the first external electrode 510 and the second external electrode 520 may be spaced apart from each other in the first slit S1, and the third external electrode 530 and the fourth external electrode 540 may be spaced apart from each other in the second slit S2.

The coils 300 and 400 of the coil component 4000 according to the embodiment may include protrusions 351 and 352, 451, and 452 connected to external electrodes 510 and 520, 530, and 540, respectively.

An outermost turn of the first coil 300 may include a first protrusion 351 in contact with the first external electrode 510, and a second protrusion 352 in contact with the second external electrode 520, and an outermost turn of the second coil 400 may include a third protrusion 451 in contact with the third external electrode 530, and a fourth protrusion 452 in contact with the fourth external electrode 540.

Specifically, the first coil 300 may include a first coil portion 311 disposed on an upper layer and a second coil portion 312 disposed on a lower layer with respect to the direction in FIG. 9, and may include a first lead-out portion 331 connected to the outermost end of the first coil portion 311, and a second lead-out portion 332 connected to the outermost end of the second coil portion 312.

Also, the first protrusion 351 may be disposed on the first lead-out portion 331, the second lead-out portion 332 may be connected to the first sub-lead-out portion 340 of the upper layer through a via, and the second protrusion 352 may be disposed on the first sub-lead-out portion 340.

Similarly, the second coil 400 may include a third coil portion 411 disposed on an upper layer and a fourth coil portion 412 disposed on a lower layer with respect to the direction in FIG. 9, and may include a third lead-out portion 431 connected to the outermost end of the third coil portion 411, and a fourth lead-out portion 432 connected to the outermost end of the fourth coil portion 412.

Also, the third protrusion 451 may be disposed on the third lead-out portion 431, the fourth lead-out portion 432 may be connected to the second sub-lead-out portion 440 on the upper layer through a via, and the fourth protrusion 452 may be disposed on the second sub-lead-out portion 440.

When having the same structure as that of the coil component 4000 according to the embodiment, even in the case of a coupled inductor including two coils 300 and 400 internally, four external electrodes 510 and 520, 530, and 540 may be disposed on the first surface 101 of the body 100, which may be advantageous for implementing low-profile.

### Process of Manufacturing Coil Component

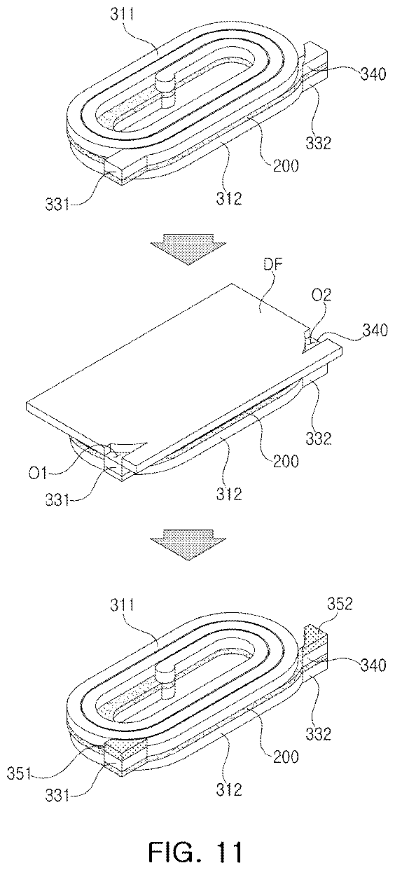

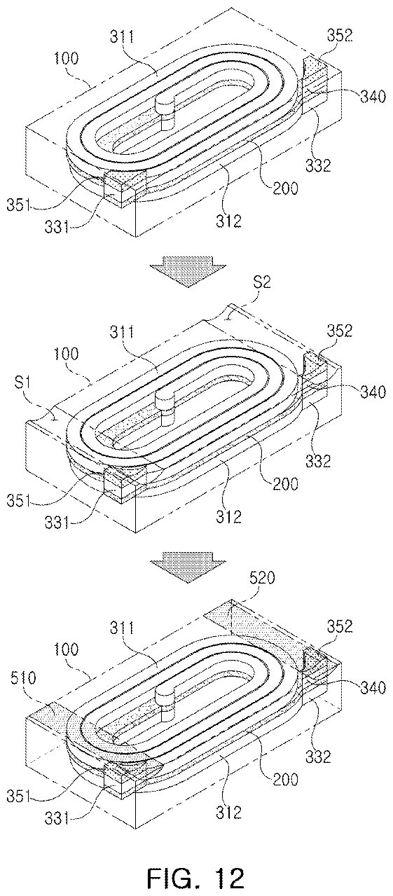

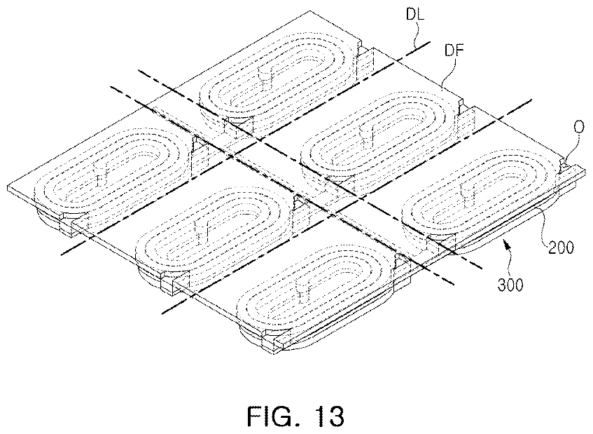

FIGS. 11 and 12 are diagram illustrating a method of manufacturing a coil component according to a first embodiment. FIG. 13 is a diagram illustrating a state in which a dry film is disposed to form a protrusion in a coil bar unit.

FIG. 11 is a diagram illustrating the stage before a body 100 is formed, and FIG. 12 is a diagram illustrating the stage after the body 100 is formed, slits S1 and S2 are formed and external electrodes 510 and 520 are disposed, the processes up to manufacturing the coil component.

Referring to FIG. 11, coil portions 311 and 312, lead-out portions 331 and 332, and sub-lead-out portions 340 may be formed through a plating process on a support member 200 on which a via hole is formed.

Although not illustrated, innermost ends of the first coil portion 311 and the second coil portion 312 may be connected through the first via 321, and the sub-lead-out portion 340 and the second lead-out portion 332 may be connected through the second via 322.

Thereafter, a dry film DF covering upper surfaces of the first coil portion 311, the first lead-out portion 331, and the sub-lead-out portion 340 may be disposed. An opening O1 or O2 having a shape corresponding to a protrusion 351 or 352 may be formed in the dry film DF.

Thereafter, the protrusions 351 and 352 may be formed through additional plating while the dry film DF having openings O1 and O2 is disposed. The first protrusion 351 may be disposed on the first lead-out portion 331, and the second protrusion 352 may be disposed on the sub-lead-out portion 340.

Referring to FIG. 12, the body 100 may be formed by laminating a magnetic sheet in the vertical direction on the coil 300 and the support member 200 disposed up to the protrusions 351 and 352.

Thereafter, the slits S1 and S2 may be formed on the first surface 101 of the body 100, and the depth of the slits S1 and S2 may be adjusted to be in contact with the protrusions 351 and 352. The formation of the slits S1 and S2 may be performed through a pre-dicing process using a dicing blade, and a pre-dicing depth may be adjusted such that a portion of the protrusions 351 and 352 may be removed together.

Thereafter, the first external electrode 510 may be disposed on the first slit S1 and the second external electrode 520 may be disposed on the second slit S2 through a plating or paste process.

Accordingly, the first external electrode 510 may be in direct contact with the first protrusion 351 exposed through the first slit S1, and the second external electrode 520 may be in direct contact with the second protrusion 352 exposed through the second slit S2.

Here, the processes in FIGS. 11 and 12 may be performed at a coil bar level except for the final coil component 1000 stage in FIG. 12.

The coil bar level may indicate that a process is performed while multiple coils are connected to each other as illustrated in FIG. 13, and may increase efficiency when processes such as the plating the coil 300, the forming the slit S1 and S2, the disposing the external electrode 510 and 520, and the body 100 insulation are performed.

After being disposed from the coil bar level to the external electrodes 510 and 520, by performing a full-dicing process along the dicing line DL, individualization of the coil component 1000 may be performed.

According to the aforementioned example embodiments, by disposing the external electrode to be embedded in one surface of the body, a thickness of the entire coil component including the external electrode may be reduced.

According to another aspect, by further disposing a protrusion on the lead-out portion of the coil, even when the depth of the slit is shallow, reliability of the connection between the coil and the external electrode may be maintained, such that a more effective volume may be assured as compared to a coil component having the same thickness.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body including a first surface and a second surface opposing each other in a first direction, and a slit disposed in the first surface;
a coil disposed in the body and including a coil portion having at least one turn, a lead-out portion extending from an outermost turn of the coil portion, and a protrusion extending to the slit; and
an external electrode disposed on the slit to be in contact with the protrusion.

2. The coil component of claim 1, wherein at least a portion of the protrusion is coplanar with the slit.

3. The coil component of claim 1, wherein an inner surface of the slit includes a curved surface.

4. The coil component of claim 1, wherein the external electrode is embedded in the body and does not protrude further than the first surface.

5. The coil component of claim 1,
wherein the body further includes a third surface and a fourth surface opposing each other in a second direction perpendicular to the first direction, and
wherein the slit is spaced apart from the third surface and the fourth surface.

6. The coil component of claim 1,
wherein the body further includes a third surface and a fourth surface opposing each other in a second direction perpendicular to the first direction, and a fifth surface and a sixth surface opposing each other in a third direction perpendicular to the first and second directions, respectively, and
wherein the slit extends to the fifth surface and the sixth surface.

7. The coil component of claim 6, further comprising:
a support member on which the coil is disposed and having one surface and the other surface opposing each other,
wherein the coil portion includes a first coil portion disposed on the one surface of the support member, and a second coil portion disposed on the other surface of the support member, and
wherein the first coil portion and the second coil portion are connected to each other through a first via.

8. The coil component of claim 7,
wherein the lead-out portion includes a first lead-out portion extending from an outermost turn of the first coil portion, and a second lead-out portion extending from an outermost turn of the second coil portion, and
wherein the coil further includes a sub-lead-out portion spaced apart from the first coil portion on the one surface of the support member.

9. The coil component of claim 8,
wherein the slit includes a first slit and a second slit spaced apart from each other in the second direction,
wherein the protrusion includes a first protrusion disposed on the first lead-out portion, and a second protrusion disposed on the sub-lead-out portion, and
wherein the first protrusion extends to the first slit, and the second protrusion extends to the second slit.

10. The coil component of claim 8, wherein the second lead-out portion and the sub-lead-out portion are connected to each other through a second via.

11. The coil component of claim 8, wherein the first lead-out portion extends to the third surface, and the second lead-out portion extends to the fourth surface.

12. The coil component of claim 8, wherein the first lead-out portion and the second lead-out portion extend to the fifth surface.

13. The coil component of claim 8, wherein the first lead-out portion extends to the fifth surface, and the second lead-out portion extends to the sixth surface.

14. The coil component of claim 9, wherein a boundary surface is disposed at least one of regions between the first protrusion and the first lead-out portion and between the second protrusion and the sub-lead-out portion.

15. The coil component of claim 1, wherein the protrusion is disposed on a level between the first surface and turns of the coil portion.

16. A coil component, comprising:
a body including a slit disposed in one surface of the body;
a first coil and a second coil disposed in the body, including a protrusion extending to the slit, having a turn in the same direction, and spaced apart from each other; and
an external electrode disposed on the slit to be in contact with the protrusion,
wherein an innermost turn of the first coil forms a turn around a first core, and an innermost turn of the second coil forms a turn around a second core.

17. The coil component of claim 16, wherein an outermost turn of the first coil surrounds the first core and the second core together, and an outermost turn of the second coil surrounds the first core and the second core together.

18. The coil component of claim 16,
wherein the slit includes a first slit and a second slit spaced apart from each other, and
wherein the external electrode includes a first external electrode and a second external electrode spaced apart from the first slit, and a third external electrode and a fourth external electrode spaced apart from the second slit.

19. The coil component of claim 18,
wherein an outermost turn of the first coil includes a first protrusion in contact with the first external electrode, and a second protrusion in contact with the second external electrode, and
wherein an outermost turn of the second coil includes a third protrusion in contact with the third external electrode, and a fourth protrusion in contact with the fourth external electrode.

20. The coil component of claim 16, wherein the protrusion is disposed on a level between the one surface and turns of the first coil or the second coil.
